(19) United States
(12) Patent Application Publication
(10) Pub. No.: US 2018/0137443 A1
(43) Pub. Date: May 17, 2018

(54) PROMOTION ARTIFACT RISK ASSESSMENT

(71) Applicant: HEWLETT PACKARD ENTERPRISE DEVELOPMENT LP, Houston, TX (US)

(72) Inventors: Meshi Peer, Yehud (IL); Omri Zisovitch, Yehud (IL); Avigail Oron, Yehud (IL)

(21) Appl. No.: 15/579,211

(22) PCT Filed: Jun. 5, 2015
(86) PCT No.: PCT/US2015/034377

§ 371 Date: Dec. 3, 2017

Related U.S. Application Data
(60) Provisional application No. 62/170,619, filed on Jun. 3, 2015.
(60) Provisional application No. 62/170,604, filed on Jun. 3, 2015.

(51) Int. Cl. G06Q 10/06

(52) U.S. Cl. CPC G06Q 10/0635; G06Q 10/0633

(57) ABSTRACT

In one example of the disclosure, a promotion artifact is received, the promotion artifact for implementation at a computer system. An origin environment is identified. A risk probability is determined for each of a set of artifacts included within the promotion artifact, the risk probability based upon a community rating and a count of artifact dependencies for the artifact. A risk impact is determined for each of the set of the artifacts. A risk assessment for implementation of the promotion artifact at the computer system is determined based upon the origin environment, and upon the risk probability and the risk impact determined for each of the artifacts.

### BACKGROUND

In an automation production environment, software engineers may develop system workflows for automated execution on a regular basis (e.g., weekly, daily, hourly, etc.). In this manner, incident identification, incident remediation, change management, and other significant tasks and processes can be performed on a scheduled basis. For instance, an e-commerce company may have a need to perform periodic maintenance upon its billing server, and an IT service can cause such maintenance to be performed automatically at scheduled intervals utilizing promoted automation workflows.

### DRAWINGS

FIG. 1 is a block diagram depicting an example environment in which various examples of the disclosure may be implemented.

FIG. 2 is a block diagram depicting an example of a system to enable promotion artifact risk assessment.

FIG. 3 is a block diagram depicting a memory resource and a processing resource to implement examples of a system to enable promotion artifact risk assessment.

FIGS. 4 and 5 illustrate an example of a system for promotion artifact risk assessment that includes provision of a risk assessment for display at a computing device.

FIG. 6 is a flow diagram depicting implementation of an example of a method to assess risk with respect to a promotion artifact.

FIG. 7 is a flow diagram depicting implementation of an example of a method for promotion artifact risk assessment based upon a determined risk probability and upon a determined risk impact.

### DETAILED DESCRIPTION

Introduction:

Before running automation workflows on a production environment, artifacts relative to the workflow are typically tested in a test environment (e.g., a development or staging environment). As used herein, a “workflow” refers to a sequence of automated steps and/or transitions, through which a specific task is to be accomplished. As used herein, an “artifact” refers generally to a workflow and its components (e.g., code to implement the workflow).

After the artifacts are validated in a particular environment (e.g., a development or staging environment), they may be promoted to another environment (e.g., a production environment). As used herein, a “promoted” or “promotion” refers generally to movement of an artifact from one environment to another environment (e.g., from a development environment to a staging environment, from a staging environment to a production environment, or from a development environment to a production environment). As used herein, a “production environment” refers generally to a setting or other environment in which an artifact is put into operation for their intended use for the benefit of an end user. A production environment is in contrast with a development, staging, or other test environment in which an artifact is still being used theoretically.

Promotion of artifacts to a production environment may include deploying new artifacts, updating existing artifacts, and or changing dependencies between artifacts. Such deployments, updates, and changes can be complex and may require thorough testing and risk assessment as part of promotion. In current solutions, an entity may be compelled to have user's manually assess the risk, map the dependencies and create a list of tests when promoting new workflows. This manual process can require a high degree of understanding of the workflows and the existing environment, and in some instances can be lengthy and error prone.

To address these issues, various examples described in more detail below provide a system and a method for promotion artifact risk assessment. In examples, a promotion artifact, the promotion artifact for implementation at a computer system, is received. An origin environment for the promotion artifact is identified. A risk probability is determined for each of a set of artifacts included within the promotion artifact. The risk probability is determined based upon a community rating and a count of artifact dependencies for the artifact. A risk impact is determined for each of the set of the artifacts. A risk assessment for implementation of the promotion artifact at the computer system is determined based upon the origin environment, and upon the risk probability and the risk impact determined for each of the artifacts. In examples, the determined risk assessment may be provided to a computing device for display via a display component included within or connected to the device.

In this manner, the disclosed examples provide an efficient and easy to use method and system to automatically and reliably assess risk associated with promotion artifacts. The disclosed examples should result in increased accuracy in risk assessment utilizing user usage trends, reduction of automation failures in production, reduction in the number promotion test cases to be run, and reduction in the time from development to production of artifacts. These advantages should in turn result in entities that implement the disclosed examples benefiting from an increased return on investment with respect to their automated production environments, and result in increased user satisfaction with respect to applications deployed from such automated production environments.

The following description is broken into sections. The first, labeled “Environment,” describes an environment in which various examples may be implemented. The second section, labeled “Components,” describes examples of various physical and logical components for implementing various examples. The third section, labeled “Illustrative Example,” presents an example of artifact promotion risk assessment. The fourth section, labeled “Operation,” describes implementation of various examples.

Environment:

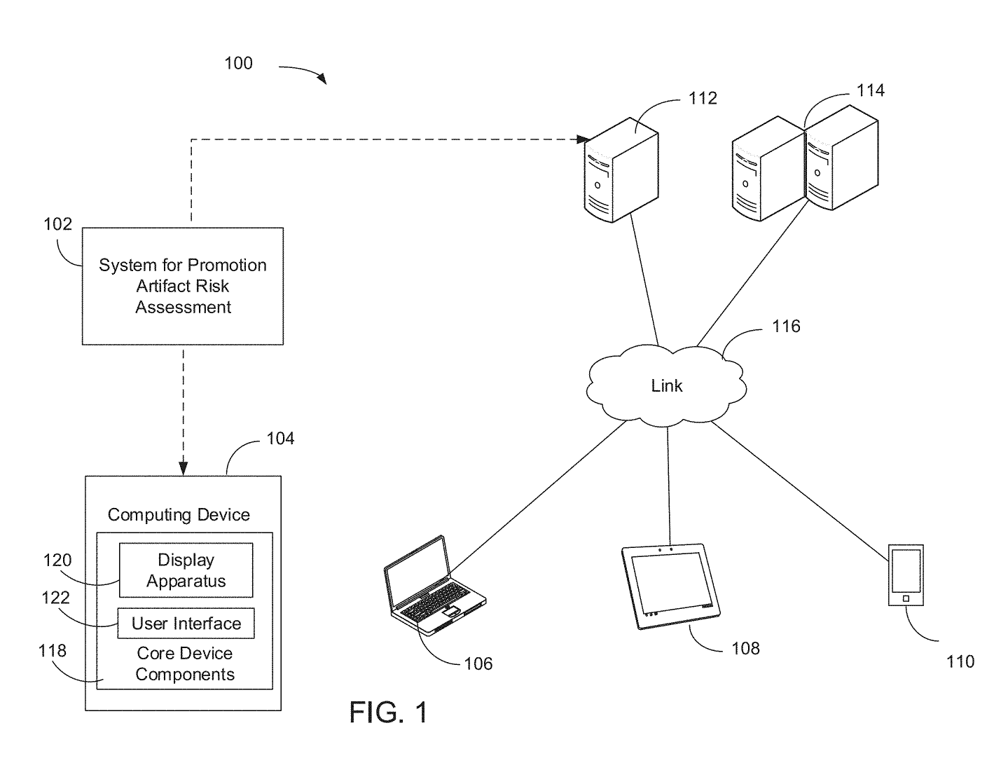

FIG. 1 depicts an example environment 100 in which examples may be implemented as a system 102 for assessment of promotion artifact risk. Environment 100 is shown to include computing device 104, client devices 106, 108, and 110, server device 112, and server devices 114. Components 104-114 are interconnected via link 116.

Link 116 represents generally any infrastructure or combination of infrastructures to enable an electronic connection, wireless connection, other connection, or combination thereof, to enable data communication between components 104-114. Such infrastructure or infrastructures may include, but are not limited to, a cable, wireless, fiber optic, or remote connections via telecommunication link, an infrared link, or a radio frequency link. For example, link 116 may represent the internet, intranets, and any intermediate routers, switches, and other interfaces. As used herein an “electronic connection” refers generally to a transfer of data between components, e.g., between two computing devices, that are connected by an electrical conductor. A “wireless connection” refers generally to a transfer of data between two components, e.g., between two computing devices, that are not directly connected by an electrical conductor. A wireless connection may be via a wireless communication protocol or wireless standard for exchanging data.

Client devices 106, 108, and 110 represent generally any computing device with which a user may interact to communicate with other client devices, server device 112, and/or server devices 114 via link 116. Server device 112 represents generally any computing device to serve an application and corresponding data for consumption by components 104-110 and 114. Server devices 114 represent generally a group of computing devices collectively to serve an application and corresponding data for consumption by components 104-110 and 112.

Computing device 104 represents generally any computing device with which a user may interact to communicate with client devices 106-110, server device 112, and/or server devices 114 via link 116. Computing device 104 is shown to include core device components 118. Core device components 118 represent generally the hardware and programming for providing the computing functions for which device 104 is designed. Such hardware can include a processor and memory, a display apparatus 120, and a user interface 122. The programming can include an operating system and applications. Display apparatus 120 represents generally any combination of hardware and programming to exhibit or present a message, image, view, or other presentation for perception by a user, and can include, but is not limited to, a visual, tactile or auditory display. In examples, the display apparatus 120 may be or include a monitor, a touchscreen, a projection device, a touch/sensory display device, or a speaker. User interface 122 represents generally any combination of hardware and programming to enable interaction between a user and device 104 such that the user may effect operation or control of device 104. In examples, user interface 122 may be, or include, a keyboard, keypad, or a mouse. In some examples, the functionality of display apparatus 120 and user interface 122 may be combined, as in the case of a touchscreen apparatus that may enable presentation of images at device 104, and that also may enable a user to operate or control functionality of device 104.

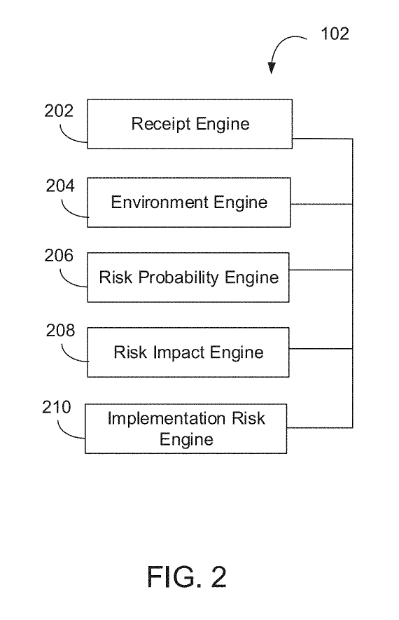

System 102, discussed in more detail below, represents generally a combination of hardware and programming to enable promotion artifact risk assessment. In some examples, system 102 may be wholly integrated within core device components 118. In other examples, system 102 may be implemented as a component of any of computing device 104, client devices 106-110, server device 112, or server devices 114 where it may take action based in part on data received from core device components 118 via link 116. In other examples, system 102 may be distributed across computing device 104, and any of client devices 106-110, server device 112, or server devices 114. For example, components that implement the receipt engine 202 (FIG. 2) functionality of receiving a promotion artifact and the environment engine 204 (FIG. 2) functionality of identifying an origin environment for the promotion artifact may be included within computing device 104. Continuing with this example, components that implement the risk probability engine 206 (FIG. 2) functionality of determining a risk probability for each of a set of artifacts included within the promotion artifact, the risk impact engine 208 (FIG. 2) functionality of determining a risk impact for each of the set of the artifacts, and the implementation risk engine 210 (FIG. 2) functionality of determining a risk assessment for implementation of the promotion artifact based upon the origin environment, and upon the risk probability and the risk impact determined for each of the artifacts, may be components included within a server device 112. Other distributions of system 102 across computing device 104, client devices 106-110, server device 112, and server devices 114 are possible and contemplated by this disclosure. It is noted that all or portions of system 102 to enable promotion artifact risk assessment may also be included on client devices 106, 108 or 110.

Components:

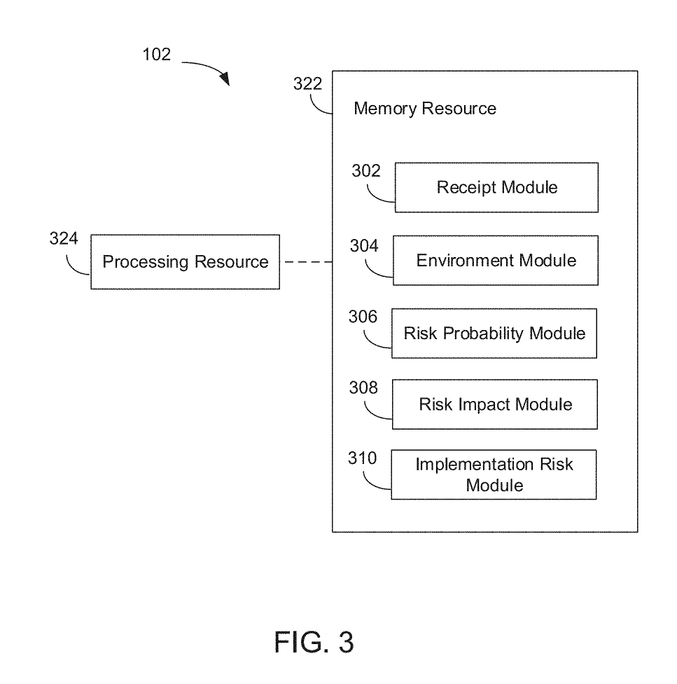

FIGS. 2 and 3 depict examples of physical and logical components for implementing various examples. In FIG. 2 various components are identified as engines 202, 204, 206, 208, and 210. In describing engines 202-210 focus is on each engine's designated function. However, the term engine, as used herein, refers generally to a combination of hardware and programming to perform a designated function. As is illustrated later with respect to FIG. 3, the hardware of each engine, for example, may include one or both of a processor and a memory, while the programming may be code stored on that memory and executable by the processor to perform the designated function.

FIG. 2 is a block diagram depicting components of a system 102 to enable promotion artifact risk assessment. In this example, system 102 includes receipt engine 202, environment engine 204, risk probability engine 206, risk impact engine 208, and implementation risk engine 210. In performing their respective functions, engines 202-210 may access a data repository, e.g., any memory accessible to system 102 that can be used to store and retrieve data. In an example, receipt engine 202 represents generally a combination of hardware and programming to receive a promotion artifact for implementation at a computer system. As used herein, a “promotion artifact” refers generally to an artifact to be moved from one environment to another environment (e.g., from a development environment to a production environment, or from a staging environment to a production environment). In an example, the promotion artifact may be received from a first computer, e.g., e.g., such as computer system 112 (FIG. 1), wherein the promotion artifact if for implementation at a second computer system (e.g., computer system 114 (FIG. 1). In another example, the promotion artifact may be received from a first computer system, e.g., computer system 112 (FIG. 1), wherein the promotion artifact if for implementation at that same first computer system.

In certain examples, receipt engine 202 may analyze the promotion artifact to identify a set of artifacts that are included within the promotion artifact. For instance, if the promotion artifact is a “send email” workflow to send emails in connection with a billing server, receipt engine 202 may identify a set of artifacts included within the promotion artifact including, for instance, an “update directory” workflow, a “create file” workflow, an “apply patch” workflow, an “archive patch” workflow, and any other artifacts included in the particular promotion artifact (e.g., an application, software, a computer file, image file, database, etc. included within the promotion artifact).

Environment engine 204 represents generally a combination of hardware and programming to identify an origin environment for the promotion artifact. As used herein, an “origin environment” refers generally to a setting or other environment from which the promotion artifact is received. In an example, the origin may be one of a development environment, a staging environment, and a production environment. In other examples, other taxonomies that distinguish various pre-production and/or production environments (e.g., where the artifact is being used theoretically or in some other manner short of a full production use).

Continuing with the example of FIG. 2, risk probability engine 206 represents generally a combination of hardware and programming to determine, for each of a set of artifacts included within the promotion artifact, a risk probability. In a particular example, the set of artifacts may be a set identified by receipt engine 202 having analyzed the promotion artifact to identify the set of artifacts. Risk probability engine 206 determines the risk probability for each artifact based upon a community rating and a count of artifact dependencies for the artifact. As used herein, a “community rating” refers generally to a rating determined based upon scores, comments, feedback, or other input from a group of users with a common characteristic or interest. In an example, the community rating is a rating for the promotion artifact and the community is a community of users of the system in which the promotion artifact is to be implemented. As used herein, a “rating” refers generally to a ranking, score, grade, value, or other rating, measure, or assessment of performance or accomplishment. In another example, the community rating may be an average of user ratings for the promotion artifact, wherein the users are members of a community of users of an application or workflow that is hosted by the a system and that is or will be impacted by the promotion artifact.

In an example, risk probability engine 206 may determine the risk probability based upon a count of other artifacts that are dependent upon the artifact. In another example, risk probability engine 206 may determine the risk probability based upon a count of a count of other artifacts upon which the artifact is dependent. In a particular example, risk probability engine 206 may determine the risk probability based upon a predictive formula that has as a first variable a number of other artifacts that are dependent upon the artifact and a second variable that is a number of other artifacts upon which the artifact is dependent. This example predictive formula thus considers a subject artifact's dependencies upon other artifacts and considers other artifacts' dependencies upon the subject artifact, such that risk probability engine 206 determines a higher risk probability for an artifact in a situation where the number of dependencies exceeds a predetermined threshold that is considered a “high” count of dependencies.

In an example, risk probability engine 206 may determine the risk probability for each of the set of artifacts based upon a count of a number of steps and/or a count of a number of transitions (e.g., a transition from state to another) associated with the artifact, the indicating how complex the artifact is. In a particular example, risk probability engine 206 may count, for a script artifact among the set analyzed set of artifacts, a number of steps and/or a number of transitions between steps included in the code instructions for the script artifact. In a particular example, risk probability engine 206 may in determining the risk probability for each of the set of artifacts may utilize a predictive formula that includes as a variable a count of the number of steps and/or transitions associated with the artifact, and that determines a higher risk probability for the artifacts in situations where the number of steps or transitions meets or exceeds a predefined threshold that is considered “high.”

In another example, risk probability engine 206 may determine the risk probability for each of the set of artifacts based upon a historical problem change count or other usage history for the artifact. As used herein, a “historical problem change count” refers generally to a count of changes to an artifact identified (e.g., by a user or a system) as problematic. For instance, risk probability engine 206 may in determining the risk probability for each of the set of artifacts may utilize a predictive formula that has as a variable a count of the number of historical change problems associated with each artifact of the set. In an example, the predictive formula may be a formula that is structured such that the risk probability engine 206 determines a higher risk probability for the artifacts in situations where the count of the number of historical change problems associated with an artifact meets or exceeds a predefined threshold that is considered a “high” count.

In another example, risk probability engine 206 may determine the risk probability for each of the set of artifacts based upon a run frequency count for the artifact. As used herein, a “run frequency count” refers generally to a count of times that an artifact is run, executed, or for certain artifacts, accessed. For instance, risk probability engine 206 may in determining the risk probability for each of the set of artifacts may utilize a predictive formula that has as a variable a count of the number of runs or executions of artifact during a prescribed time period. This predictive formula thus consider current usage of the artifact, such that risk probability engine 206 determines higher risk probability for the artifacts in situations where the run frequency count exceeds a predefined threshold that is considered a “high” count.

In another example, risk probability engine 206 may determine the risk probability, for each artifact of the set of artifacts, based upon a count of APIs for which a change is to be made with respect to the artifact. For instance, risk probability engine 206 may in determining the risk probability for each of the set of artifacts may utilize a predictive formula that has as a variable a count of API changes to occur relative to the artifact. As used herein, a “change to an API” refers generally to a modification to an API, e.g. a modification to an input or output of the API. As used herein, a “changed API” refers generally to a modified API. This predictive formula thus considers the number of API changes to be made for each of the set of artifacts in connection with the implementation of the promotion artifact, such that risk probability engine 206 determines a higher risk probability for the artifacts in situations where the number of API changes exceeds a predefined threshold that is considered a “high” count.

In a particular example, risk probability engine 206 may determine the risk probability for each of the set of artifacts included within the promotion artifact utilizing the predictive formula

$$Artifact Probability of Risk ( “ APR ” ) = \frac{1}{P} ( DY + DT + H + NS + C )$$

where “P” is a community rating for a subject artifact, “DY” is a count of dependencies the subject artifact has on other artifacts, “DT” is a count of artifacts dependent on the subject artifact, “H” is a count of historical change problems, “NS” is a count of a number of steps and transitions included within the subject artifact, and “C” is a count of API changes with respect to the subject artifact.

Risk impact engine 208 represents generally a combination of hardware and programming to determine a risk impact for each of the set of the artifacts included within the promotion artifact. In an examples, risk impact engine 208 determines a risk impact for each of the set of artifacts based upon a comparison of an expected return or an expected value attributable to the promotion artifact relative to an expected return attributable to an application or system that is to include the promotion artifact. As used herein, an “expected return” refers generally to an expected yield, profit, revenue, interest, dividend, savings, gain, or other value. As used herein, an “expected value” refers generally to an expected importance, worth, or usefulness of something expressed in a numerical manner. In examples, the expected return and/or expected value may be expressed as a monetary expected return or a monetary expected value.

For instance, risk probability engine 208 in determining the risk impact for each of the set of artifacts may utilize a predictive formula that includes a term with a numerator that includes expected return or expected value attributable to the promotion artifact and includes a denominator with an expected return attributable to the entire application or system that is to include the promotion artifact.

In a particular example, risk probability engine 208 may determine the risk impact for each of the set of artifacts may utilize the predictive formula

Artifact Impact of Risk(“AIR”)=Workflow ROI/Total System ROI*N

where “Workflow ROI” is an expected return attributable to the promotion artifact, “Total System ROI” is an expected return attributable to the entire application or system that is to include the promotion artifact, and “N” indicates a current usage of the artifact in terms of number of runs during a time period.

Implementation risk engine 210 represents generally a combination of hardware and programming to determine a risk assessment for implementation of the promotion artifact at the computer system. Implementation risk engine 210 is to determine the risk assessment based upon origin environment identified by the environment engine 204, based upon the risk probability determined by the risk probability engine, and based upon and the risk impact determined for each of the artifacts. In a particular example, implementation risk engine 210 may determine the risk assessment for implementation of the promotion artifact based upon a predictive formula

Promotion Risk Assessment(“PRA”)=O+Σₙ₌₁^{m}(APRn*AIRn)

wherein “APR” is an artifact probability of risk as determined by risk probability engine 206 and “AIR” is an artifact impact of risk as determined by risk impact engine 208.

In examples, implementation risk engine 210 may provide the determined risk assessment to a computing device for display via a display component included within or connected to a computer system. As used herein, “display” refers generally to exhibition or presentation caused by a computer for the purpose of perception by a user. In examples, a display may be a display to be presented at a computer monitor, touchscreen, projection device, or other electronic display component. As used herein, a “display component” refers generally to any combination of hardware and programming configured to exhibit or present content, a message, or other information for perception by a user, and can include, but is not limited to, a visual, tactile or auditory display. In particular examples, the display may be in a form to be presented at a monitor, display screen, or touchscreen component of a computing device. In examples, the display may include a graphic user interface to enable user interaction with the display. As used herein, “graphic user interface” and “GUI” are used synonymously, and refer generally to any type of display caused by an application that can enable a user to interact with the application via visual properties of the display.

In an example, implementation risk engine 210 may determine a recommendation for testing of a subset of the set of artifacts that are dependent upon the promotion artifact and provide the recommendation to the computing device for display via the display component.

In an example, implementation risk engine 210 may determine a subset of the set of artifacts that are artifacts for which API changes are to be made to implement the promotion artifact, and may provide the subset of artifacts to the computing device for display via the display component.

In examples, receipt engine 202 may receive the promotion artifact from a computer system over a link 116 via a networking protocol, and implementation risk engine 210 may provide the determined risk assessment (and in particular examples, may provide a recommendation to test and/or may provide a subset of artifacts that are artifacts for which API changes are to be made) to a computer system over a link 116 via a networking protocol. In examples the networking protocol may include, but is not limited to, Transmission Control Protocol/Internet Protocol (“TCP/IP”), HyperText Transfer Protocol (“HTTP”), and/or Session Initiation Protocol (“SIP”).

In the foregoing discussion of FIG. 2, engines 202-210 were described as combinations of hardware and programming. Engines 202-210 may be implemented in a number of fashions. Looking at FIG. 3 the programming may be processor executable instructions stored on a tangible memory resource 322 and the hardware may include a processing resource 324 for executing those instructions. Thus memory resource 322 can be said to store program instructions that when executed by processing resource 324 implement system 102 of FIG. 2.

Memory resource 322 represents generally any number of memory components capable of storing instructions that can be executed by processing resource 324. Memory resource 322 is non-transitory in the sense that it does not encompass a transitory signal but instead is made up of more or more memory components to store the relevant instructions. Memory resource 322 may be implemented in a single device or distributed across devices. Likewise, processing resource 324 represents any number of processors capable of executing instructions stored by memory resource 322. Processing resource 324 may be integrated in a single device or distributed across devices. Further, memory resource 322 may be fully or partially integrated in the same device as processing resource 324, or it may be separate but accessible to that device and processing resource 324.

In one example, the program instructions can be part of an installation package that when installed can be executed by processing resource 324 to implement system 102. In this case, memory resource 322 may be a portable medium such as a CD, DVD, or flash drive or a memory maintained by a server from which the installation package can be downloaded and installed. In another example, the program instructions may be part of an application or applications already installed. Here, memory resource 322 can include integrated memory such as a hard drive, solid state drive, or the like.

In FIG. 3, the executable program instructions stored in memory resource 322 are depicted as receipt module 302, environment module 304, risk probability module 306, risk impact module 308, and implementation risk module 310. Receipt module 302 represents program instructions that when executed by processing resource 324 may perform any of the functionalities described above in relation to receipt engine 202 of FIG. 2. Environment module 304 represents program instructions that when executed by processing resource 324 may perform any of the functionalities described above in relation to environment engine 204 of FIG. 2. Risk probability module 306 represents program instructions that when executed by processing resource 324 may perform any of the functionalities described above in relation to risk probability engine 206 of FIG. 2. Risk impact module 308 represents program instructions that when executed by processing resource 324 may perform any of the functionalities described above in relation to risk impact engine 208 of FIG. 2. Implementation risk module 310 represents program instructions that when executed by processing resource 324 may perform any of the functionalities described above in relation to implementation risk engine 210 of FIG. 2.

### Illustrative Example

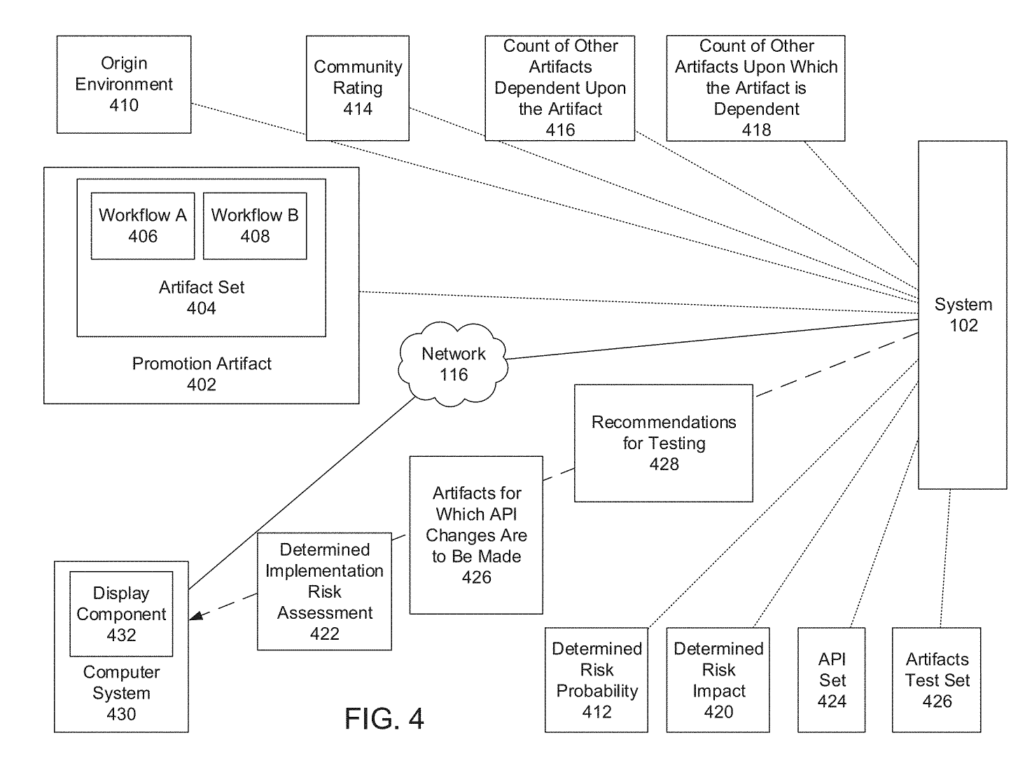

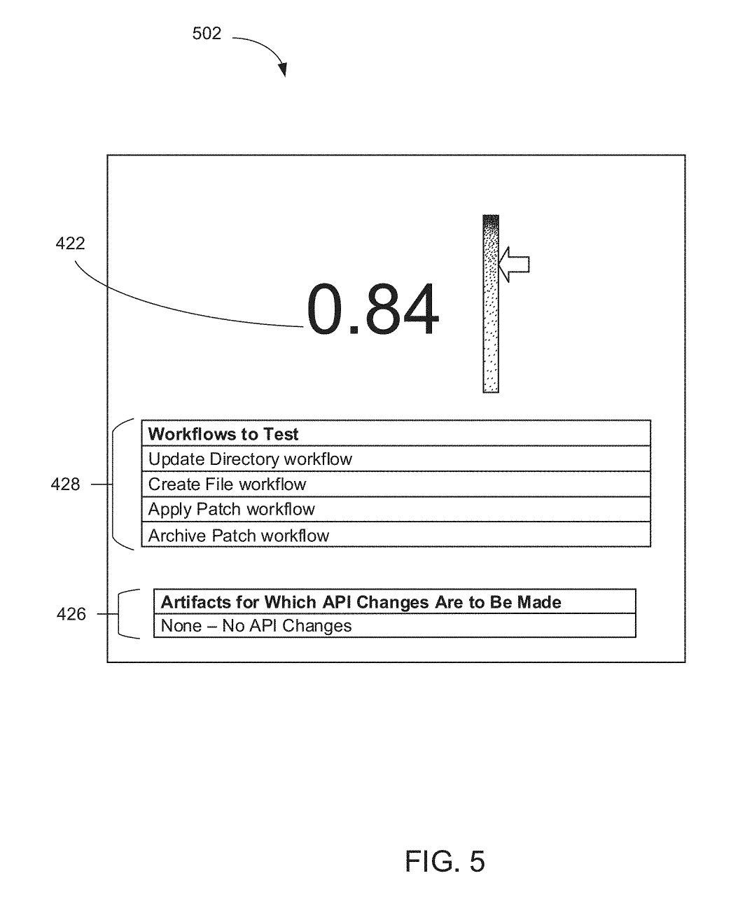

FIGS. 4 and 5, in view of FIGS. 1 and 2, illustrate an example of a system 102 for assessment of promotion artifact risk. In examples, system 102 may be hosted at a computer system such as server device 112 (FIG. 1) or distributed over a set of computer systems such as server system 114 (FIG. 1). Beginning at FIG. 4, in this example, system 102 receives, via a network 116, a promotion artifact 402, e.g., a promotion artifact for testing of an email utility in a system that is to be promoted from a development environment to a Quality Assurance (“QA”) environment. In this example, the promotion artifact 402 includes an artifact set 404 including two artifacts that are workflows (“Workflow A” 406 and “Workflow B” 408). In this example, the Workflow A and Workflow B artifacts are artifacts already available at an implementation computer system in an older version.

System 102 identifies a development environment as the origin environment 410 for the promotion artifact 402 and assigns a value to origin environment variable “O” in the following formula:

Promotion Risk Assessment(“PRA”)=O+Σₙ₌₁^{m}(APRn*AIRn).

In this particular formula, “APR” represents an Artifact Probability of Risk (a risk probability) and “AIR” represents an Artifact Impact of Risk (a risk impact). In this example variable “m” is the number of artifacts in the set of artifacts included within the promotion artifact. In this particular example, system 102 utilizing this Promotion Risk Assessment Formula assigns a value of “0.2” to the origin environment variable “O” as system 102 identified the origin environment as a development environment. In this example, system 102 would assign a value of “0.3” to the origin environment variable “O” in the event the origin environment is a staging environment, or would assign a value of “0.4” to the origin environment variable “O” in the event the origin environment is a production environment. Other value assignments with respect to origin environments are possible and are contemplated by this disclosure. The predictive formula applied by system 102 includes as a factor the origin environment for the promotion artifact, such that system 102 determines a higher promotion risk assessment in situations where the origin environment is a production environment, and a lower risk assessment where the origin environment is a development environment.

Continuing at FIG. 4, system 102 determines, for each of “Workflow A” and “Workflow B” a risk probability 412 determined in consideration of a community rating 414, a count 416 of other artifacts dependent upon the subject artifact, and a count 418 of artifacts upon which the subject artifact is dependent. In this example, system 102 determines risk probabilities 412 for each of the artifacts Workflow A and Workflow B utilizing the following formula:

$$Artifact Probability of Risk ( “ APR ” ) = \frac{1}{P} ( DY + DT + H + NS + C ) .$$

In an example system 102 may determine a risk probability 412 for artifact “Workflow A” 406 of the set of artifacts utilizing the above formula and considering the following parameters:

Parameters for Workflow A:
DT (Artifacts dependent on this artifact): 3
DY (Dependency on other artifacts): 5
NS (Number of steps and transitions): (a complex workflow of 200 steps and 500 transitions)—700
H (Historical changes problems): 0 (in the past it was updated 3 times with no issues)
P—(Artifact credibility in the community rating): stable (8/10)—8
C—(API changes): 1.
   In this example, system 102 calculates an Artifact Probability of Risk (risk probability 412) of “89” for artifact Workflow A according the following calculations:

$$APR = \frac{1}{P} ( DY + DT + H + NS + C )$$

$$APR = 1 / 8 ( 3 + 5 + 0 + 700 + 1 ) = 89.$$

Continuing with this example, system 102 may determine a risk probability 412 for artifact “Workflow B” 408 of the set of artifacts 404 utilizing the above formula and considering the following parameters:

Parameters for Workflow B:
DT (Artifacts dependent on this artifact): 1
DY (Dependency on other artifacts): 3
NS (Number of steps and transitions): (a simple workflow of 20 steps and 30 transitions)—50
H (Historical changes problems)—0 (in the past it was updated 1 time with no issues)
P—(Artifact credibility in the community rating): stable (9/10)—9 C: 0 (there are no API changes).
   In this example, system 102 calculates an Artifact Probability of Risk (risk probability 412) of “6” for artifact Workflow B 408 according the following calculations:

$$APR = \frac{1}{P} ( DY + DT + H + NS + C )$$

$$APR = 1 / 9 ( 1 + 3 + 0 + 50 + 1 ) = 6.$$

In this example, System 102 determines an Artifact Impact of Risk (risk impact 420) for each of Workflow A and Workflow B utilizing the following formula:

Artifact Impact of Risk (“AIR”)=Workflow ROI/Total System ROI*N

In this particular formula, “Workflow ROI” represents a return on investment attributable to the artifact under consideration, “Total System ROI” represents a return on investment attributable to the an entire system at which the artifact under consideration is being promoted to, and “N” represents a number of runs during a prescribed time period.

Continuing with this example, system 102 may determine an Artifact Impact of Risk (risk impact 420) for the Workflow A 406 artifact of the set of artifacts 404 utilizing the above formula by considering the following parameters:

Parameters for Workflow A:
ROI—$12,000 per month
Total System ROI—$150,000 per month
N—It is used/run twice a month

Parameters for Workflow B:
ROI—$7,000 per month
Total System ROI—$150,000 per month
N—It is used/run 20 times per month.
   In this example, system 102 calculates an Artifact Impact of Risk (risk impact 420) of “0.16” for Workflow A 406 according the following calculations:

AIR=Workflow ROI/Total System ROI*N

AIR=$12,000/$1,500,000*2=0.016.

In this example, system 102 calculates an Artifact Impact of Risk (risk impact 420) of “0.093” for Workflow B 408 according the following calculations:

AIR=Workflow ROI/Total System ROI*N

AIR=$7,000/$1500000*20=0.093.

Continuing with this example, system 102 in turn determines an implementation risk assessment 422 for the promotion artifact 402 based upon the origin environment 410, and based upon the risk probability 412 and the risk impact 420 determined for each artifact of the set of artifacts 404. In this example, system 102 calculates an implementation risk assessment of “0.26” according the following calculations:

Promotion Risk Assessment (“PRA”)=O+Σₙ₌₁²(APRn*AIRn)

PRA=0.2(APR Workflow A*AIR Workflow A)+(APR Workflow B*AIR Workflow B)

PRA=0.2(89*0.016)+(6*0.093)

PRA=0.84.

Continuing with this example, system 102 determines a first subset of the set of artifacts 424 that are artifacts dependent upon the promotion artifact 402. In this example, the first subset of artifacts 424 is indicated in the formula by variable “DT”, such that for the promotion artifact the test set of artifacts includes the three artifacts that system identified as dependent upon Workflow A 406 and the one artifact that system 102 identified as dependent upon Workflow B 408.

Continuing at FIG. 4, system 102 provides the determined risk assessment, the recommendation 428, and the second subset of artifacts 426 to a computer system 430 for display via a display component 432 included within or connected to the computer system.

FIG. 5, in view of FIG. 4, is an example of a display 502 to be presented at computer system 430. The display includes the determined risk assessment 422, the recommendation 428, a description of the second subset of artifacts for which API changes are to occur 426. In this example, the determined risk assessment is “0.84”, the recommendation 428 is to test four artifacts that are artifacts dependent on the set of artifacts, the four artifacts including “Update Directory Workflow”, “Create File Workflow”, “Apply Patch Workflow”, and “Archive Patch Workflow”. In this example, the description of the second subset 426 is an empty set, as system 102 determined no API changes were necessary in connection with changes to Workflow A or Workflow B.

Operation:

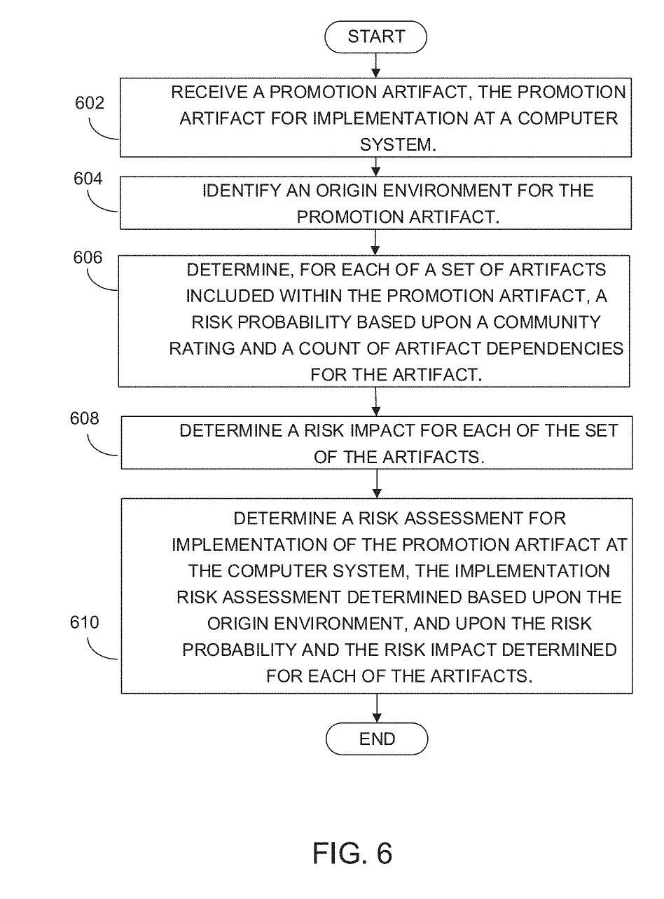

FIG. 6 is a flow diagram of implementation of a method for promotion artifact risk assessment. In discussing FIG. 6, reference may be made to the components depicted in FIGS. 2 and 3. Such reference is made to provide contextual examples and not to limit the manner in which the method depicted by FIG. 6 may be implemented. A promotion artifact is received. The promotion artifact is for implementation at a computer system (block 602). Referring back to FIGS. 2 and 3, receipt engine 202 (FIG. 2) or receipt module 302 (FIG. 3), when executed by processing resource 324, may be responsible for implementing block 602.

An origin environment for the promotion artifact is identified (block 604). Referring back to FIGS. 2 and 3, environment engine 204 (FIG. 2) or environment module 304 (FIG. 3), when executed by processing resource 324, may be responsible for implementing block 604.

For each of a set of artifacts included within the promotion artifact, a risk probability is determined based upon a community rating and a count of artifact dependencies for the artifact (block 606). Referring back to FIGS. 2 and 3, risk probability engine 206 (FIG. 2) or risk probability module 306 (FIG. 3), when executed by processing resource 324, may be responsible for implementing block 606.

A risk impact is determined for each of the set of the artifacts (block 608). Referring back to FIGS. 2 and 3, risk impact engine 208 (FIG. 2) or risk impact module 308 (FIG. 3), when executed by processing resource 324, may be responsible for implementing block 608.

A risk assessment for implementation of the promotion artifact at the computer system is determined based upon the origin environment, and based upon the risk probability and the risk impact determined for each of the artifacts (block 610). Referring back to FIGS. 2 and 3, implementation risk engine 210 (FIG. 2) or implementation risk module 310 (FIG. 3), when executed by processing resource 324, may be responsible for implementing block 610.

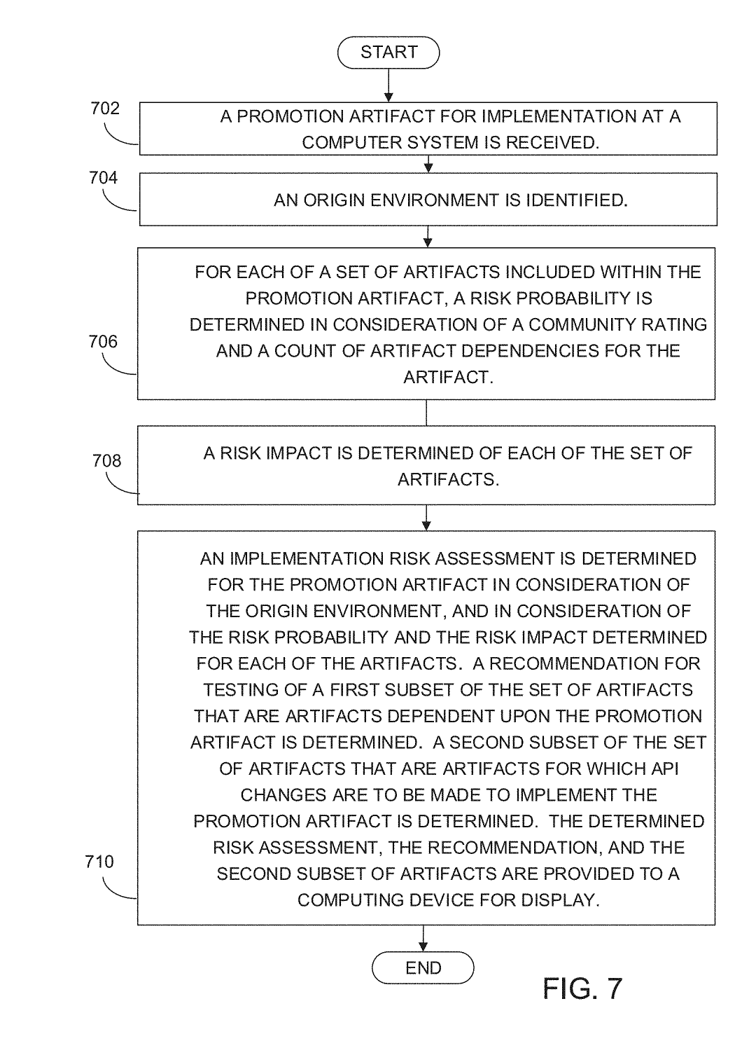

FIG. 7 is a flow diagram of implementation of a method for assessment of implementation risk for promotion artifacts. In discussing FIG. 7, reference may be made to the components depicted in FIGS. 2 and 3. Such reference is made to provide contextual examples and not to limit the manner in which the method depicted by FIG. 7 may be implemented. A promotion artifact for implementation at a computer system is received (block 702). Referring back to FIGS. 2 and 3, receipt engine 202 (FIG. 2) or receipt module 302 (FIG. 3), when executed by processing resource 324, may be responsible for implementing block 702.

An origin environment is identified (block 704). Referring back to FIGS. 2 and 3, environment engine 204 (FIG. 2) or environment module 304 (FIG. 3), when executed by processing resource 324, may be responsible for implementing block 704.

For each of a set of artifacts included within the promotion artifact, a risk probability is determined in consideration of a community rating and a count of artifact dependencies for the artifact (block 706). Referring back to FIGS. 2 and 3, risk probability engine 206 (FIG. 2) or risk probability module 306 (FIG. 3), when executed by processing resource 324, may be responsible for implementing block 706.

A risk impact is determined for each of the set of the artifacts (block 708). Referring back to FIGS. 2 and 3, risk impact engine 208 (FIG. 2) or risk impact module 308 (FIG. 3), when executed by processing resource 324, may be responsible for implementing block 708.

An implementation risk assessment is determined for the promotion artifact in consideration of the origin environment, and in consideration of the risk probability and the risk impact determined for each of the artifacts. A recommendation is determined, the recommendation for testing of a first subset of the set of artifacts that are artifacts dependent upon the promotion artifact. A second subset of the set of artifacts is determined, the second subset being artifacts for which API changes are to be made to implement the promotion artifact. The determined risk assessment, the recommendation, and the second subset of artifacts are provided to a computing device for display (block 710). Referring back to FIGS. 2 and 3, implementation risk engine 210 (FIG. 2) or implementation risk module 310 (FIG. 3), when executed by processing resource 324, may be responsible for implementing block 710.

Conclusion:

FIGS. 1-7 aid in depicting the architecture, functionality, and operation of various examples. In particular, FIGS. 1, 2 and, 3 depict various physical and logical components. Various components are defined at least in part as programs or programming. Each such component, portion thereof, or various combinations thereof may represent in whole or in part a module, segment, or portion of code that comprises executable instructions to implement any specified logical function(s). Each component or various combinations thereof may represent a circuit or a number of interconnected circuits to implement the specified logical function(s). Examples can be realized in any memory resource for use by or in connection with processing resource. A “processing resource” is an instruction execution system such as a computer/processor based system or an ASIC (Application Specific Integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory” is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagrams of FIGS. 6 and 7 show specific orders of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

The present disclosure has been shown and described with reference to the foregoing examples. It is to be understood, however, that other forms, details and examples may be made without departing from the spirit and scope of the invention that is defined in the following claims. All of the features disclosed in this specification (including any accompanying claims, abstract and drawings), and/or all of the blocks or stages of any method or process so disclosed, may be combined in any combination, except combinations where at least some of such features, blocks and/or stages are mutually exclusive.

What is claimed is:

1. A system, comprising:
a receipt engine, to receive a promotion artifact, the promotion artifact for implementation at a computer system;
an environment engine, to identify an origin environment for the promotion artifact;
a risk probability engine, to determine, for each of a set of artifacts included within the promotion artifact, a risk probability based upon a community rating and a count of artifact dependencies for the artifact;
a risk impact engine, to determine a risk impact for each of the set of the artifacts; and
an implementation risk engine, to determine a risk assessment for implementation of the promotion artifact at the computer system, the implementation risk assessment determined based upon the origin environment, and upon the risk probability and the risk impact determined for each of the artifacts.

2. The system of claim 1, wherein the implementation risk engine provides the determined risk assessment to a computing device for display via a display component included within or connected to the device.

3. The system of claim 2, wherein the implementation risk engine is to determine and provide for display via the display component a recommendation for testing of a subset of the set of artifacts that are dependent upon the promotion artifact.

4. The system of claim 2, wherein the implementation risk engine is to determine and provide for display via the display component a subset of the set of artifacts that are artifacts for which application programming interface (“API”) changes are to be made to implement the promotion artifact.

5. The system of claim 1, wherein the artifact dependencies count for each of the artifacts includes a count of other artifacts dependent upon the artifact.

6. The system of claim 1, wherein the artifact dependencies count for each of the artifacts includes a count of other artifacts upon which the artifact is dependent.

7. The system of claim 1, wherein the receipt engine is to analyze the promotion artifact to identify the set of artifacts.

8. The system of claim 1, wherein the risk probability engine is to determine the risk probability for each of the set of artifacts based upon a steps count or a transitions count for the artifact.

9. The system of claim 1, wherein the risk probability engine is to determine the risk probability for each of the set of artifacts based upon a historical problem change count for the artifact.

10. The system of claim 1, wherein the risk probability engine is to determine the risk impact for each of the set of artifacts based upon a run frequency count for the artifact.

11. The system of claim 1, wherein the risk probability engine is to, for each artifact of the set of artifacts, determine the risk probability based upon a count of changed APIs.

12. The system of claim 1, wherein the risk impact engine is to determine the risk impact for each of the set of artifacts based upon a comparison of an expected return attributable to the promotion artifact relative to an expected return attributable to an application or system that is to include the promotion artifact.

13. The system of claim 1, wherein the risk impact engine is to determine the risk impact for each of the set of artifacts based upon a comparison of an expected value attributable to the promotion artifact relative to an expected value attributable to an application or system that is to include the promotion artifact.

14. A memory resource storing instructions that when executed cause a processing resource to determine a risk assessment for implementation of a promotion artifact, the instructions comprising:
a receipt module, that when executed causes the processing resource to receive the promotion artifact, the promotion artifact for implementation at a computer system;
an environment module, that when executed causes the processing resource to identify an origin environment;
a risk probability module, that when executed causes the processing resource to determine, for each of a set of artifacts included within the promotion artifact,
a risk probability determined in consideration of a community rating and a count of artifact dependencies for the artifact;
a risk impact module, that when executed causes the processing resource to determine a risk impact for each of the set of the artifacts; and
an implementation risk module, that when executed causes the processing resource
to determine the implementation risk assessment for the promotion artifact, in consideration of the origin environment, and in consideration of the risk probability and the risk impact determined for each of the artifacts,
to determine a recommendation for testing of a first subset of the set of artifacts that are artifacts dependent upon the promotion artifact;
to determine a second subset of the set of artifacts that are artifacts for which API changes are to be made to implement the promotion artifact, and
to provide the determined risk assessment, the recommendation, and the second subset of artifacts to a computing device for display.

15. A method for assessing promotion artifact risk, comprising
obtaining a promotion artifact to be implemented at a computer system;
identifying a source environment for the promotion artifact;
for each of a set of artifacts included within the promotion artifact, calculating a risk probability that is a function of a community rating, a first count of other artifacts dependent upon the artifact, a second count of other artifacts upon which the artifact is dependent, a steps count, a historical problem change count, and a run frequency count for the artifact; and
for each of the set of artifacts, calculating a risk impact that is a function of a comparison of an expected return attributable to the promotion artifact relative to an expected return attributable to an application or system that is to include the promotion artifact; and
calculating an implementation risk assessment for the promotion artifact in consideration of the origin environment, and in consideration of the risk probability and the risk impact determined for each of the set of artifacts.
